(19) United States
(12) Patent Application Publication
(10) Pub. No.: US 2005/0003772 A1
(43) Pub. Date: Jan. 6, 2005

(54) IBOC broadcast receiver

(76) Inventor: Hiroyuki Nemoto, Iwaki-city (JP)

Correspondence Address: BRINKS HOFER GILSON & LIONE, P.O. BOX 10395, CHICAGO, IL, 60610, US

(21) Appl. No.: 10/848,565

(22) Filed: May 18, 2004

(30) Foreign Application Priority Data
May 20, 2003 (JP) 2003-141905

(51) Int. Cl. H04B 1/02

(52) U.S. Cl. 455/130; 455/101

(57) ABSTRACT

An IBOC broadcast receiver includes a diversity receiving unit for receiving a broadcast wave, a tuner unit for selecting a signal via a switch and connecting the received broadcast wave to one of a broadband filter and a narrowband filter, a demodulating unit for demodulating a signal contained in the output broadcast wave, and a controller. In accordance with a result of the demodulation performed by the demodulating unit, the controller determines whether or not the broadcast wave has an IBOC broadcast wave. When it is determined that no IBOC broadcast wave is present, the diversity receiving unit is put into an enabled state and an output of the narrowband filter is selected and processed. When it is determined that an IBOC broadcast wave is present, the diversity receiving unit is put into a disabled state and an output of the broadband filter is selected and processed.

### BACKGROUND OF THE INVENTION

1. Field of the Invention

The present invention relates to radio broadcast receivers adapted for receiving a digital audio broadcast (DAB) wave and, more particularly, to an IBOC (in-band on-channel) broadcast receiver having a function for receiving a broadcast wave transmitted in an IBOC-system modulation format using both sidebands of an existing FM/AM broadcast carrier.

2. Description of the Related Art

In conjunction with the recent digitalization of broadcasting, radio broadcasting is also becoming digitalized. For digital radio broadcasting using a satellite, XM satellite Radio Inc. and Sirius Satellite Radio Inc. launched services in September 2001 and in February 2002, respectively. In addition to the digital satellite radio broadcasting, terrestrial digital radio broadcasting, such as “HD (high definition) radio,” has been proposed by iBiquity Digital Corporation. This HD radio is expected to expand its market share in the future, since the service is offered free of charge while containing some commercial advertising, as compared to the pay digital satellite radio broadcasting.

A major feature of the HD radio is that an IBOC system in which a digital signal is added to an existing FM/AM broadcast analog radio wave is employed. This not only allows conventional analogy-system radio receivers to receive the same broadcast content but also allows HD radio receivers having a digital reception capability to receive a digital broadcast wave. During digital reception, the IBOC system provides a quality of sound comparable to that of FM-broadcast sound through AM broadcasting and provides a quality of sound equivalent to that of CD sound through FM broadcasting.

A hybrid system is one system for transmitting a broadcast wave in a digital audio broadcast (DAB) system employing the IBOC system. FIG. 1 schematically shows the broadcast wave transmission format of the hybrid system. More specifically, FIG. 1 illustrates the frequency allocation of an FM-modulated broadcast signal and IBOC DAB signals versus power spectral densities. As shown in FIG. 1, the hybrid system is an analog/digital combination in which IBOC DAB signals (a digital modulation wave) are added to the upper sideband and the lower sideband of an analog broadcast carrier (an FM analog signal), and is available in today's technology. IBOC DAB signals, added to both upper and lower sidebands of an FM analog signal, contain 95evenly-spaced orthogonal frequency division multiplex (OFDM) subcarriers, which occupy the spectrums about 129 kHz to 198 kHz away from the FM center frequency, as shown in FIG. 1. Typically, the total DAB power in the OFDM subcarriers in each sideband is set to about −25 dB relative to its FM analog power.

A typical HD radio (IBOC broadcast receiver) has a basic feature to generate sound from a signal received in a digital format (within an area where digital reception is possible) and to automatically generate sound from a signal received in an analog format (within an area where digital reception is not possible), so as to prevent sound loss or the like. Specifically, while searching for (seeking) a broadcast station, the HD radio first tunes into a frequency at which an analog broadcast wave is receivable and demodulates (reproduces) the analog broadcast wave. At the same time, the HD radio determines whether or not the analog broadcast wave has a digital demodulation wave (sidebands), that is, whether or not an IBOC broadcast station exists. Upon finding a digital modulation wave, the HD radio demodulates (reproduces) the IBOC broadcast wave, switches from the reproduced analog broadcast wave to the IBOC broadcast wave by a processing procedure called “blend,” and generates sound from the IBOC broadcast wave. On the other hand, when no digital modulation wave is found, the HD radio generates sound from the reproduced analog broadcast wave.

As an example of technology relevant to the above known art, iBiquity Digital Corporation has proposed “Modulation format (hybrid system and all-digital system) for FM IBOC DAB and broadcast method and system using the modulation format” (e.g., PCT Japanese Translation Patent Publication Nos. 2001-520479 and 2002-510897).

The IBOC broadcast receivers of the related art described above can be used for both analog broadcast reception and digital broadcast (IBOC broadcast) reception, but have the following problems.

First, IBOC broadcast stations, which provide IBOC-system digital audio broadcast (DAB) services, and analog broadcast stations, which provide existing FM/AM broadcasting services, use different bandwidths depending upon the presence/absence of digital modulation waves. That is, as shown in FIG. 1, for a broadcast wave transmitted from an IBOC broadcast station, the sidebands of an analog broadcast carrier (an FM analog signal is shown in the illustrated example) are accompanied by a digital modulation wave (IBOC DAB signals), and the bandwidth (about 400 kHz) is relatively broad, i.e., “broadband.” In contrast, for a, broadcast wave transmitted from an analog broadcast station, no digital modulation wave (sidebands) is added, so that the bandwidth is relatively narrow, i.e., “narrowband.”

When viewed from a receiver side, in order to receive an existing FM/AM broadcast wave, it is sufficient that the receiver can detect the “narrowband,” whereas, in order to receive an IBOC broadcast wave, the receiver needs to detect the “broadband.” Thus, the bandwidths to be detected are different between receiving an existing FM/AM broadcast wave and receiving an IBOC broadcast wave. Correspondingly, there is a need to change a characteristic (specifically, a frequency selection characteristic of a passband filter) required for the tuner unit of the receiver.

The tuner unit of such a known IBOC broadcast receiver, however, has a fixed frequency-selection characteristic so as to allow detection of a broadband signal. As a result, while having no particular problem in receiving an IBOC broadcast wave, the IBOC broadcast receiver has a problem in receiving an existing FM/AM signal (an analog broadcast wave). Specifically, when receiving an existing FM/AM signal, the IBOC broadcast receiver also receives an excessive frequency band other than the “narrowband” that is supposed to be detected. Thus, when a fading-induced noise component or the like is contained in the excessive frequency band, the IBOC broadcast receiver cannot faithfully reproduce a radio wave received from an analog broadcast station. This leads to a decline in the performance of analog broadcast reception.

For a fixed IBOC broadcast receiver, generally, fading that occurs at the receiver is statistically stationary. For example, installing a high-performance antenna or changing the position of the existing antenna makes it possible to effectively mitigate the influence of fading. However, when the IBOC broadcast receiver is used on a vehicle, the fading is not statistically stationary but is instead dependent upon the location and the velocity of the vehicle, thus requiring more sophisticated schemes to achieve effective mitigation. One possible scheme is a diversity system. In the diversity system, a receiver has a plurality of antennas, and a signal received by one of the antennas which has the greatest reception electric-field strength (i.e., one of the antennas that has the most favorable state) is selected as the signal from which to generate sound from, thereby improving the performance of analog broadcast reception.

However, when the diversity system is applied to an IBOC broadcast receiver, the receiver requires processing, involving synchronization and demodulation, to perform digital reception. Thus, when the diversity switching unit of the receiver performs a switching operation for switching antennas, the so-called “sync loss” can occur at the time of blend-function-based switching to a digital modulation wave. This leads to a decline in the performance of IBOC broadcast reception.

As described above, the known IBOC broadcast receiver has difficulty maintaining both the performance of analog broadcast reception and the performance of IBOC broadcast reception at satisfactory levels.

### SUMMARY OF THE INVENTION

The present invention has been made in view of the problems of the related art, and an object of the present invention is to provide an IBOC broadcast receiver that is capable of performing optimum reception with respect to both IBOC broadcasting and analog broadcasting.

To overcome the problems of the related art, the present invention provides an IBOC broadcast receiver for receiving a broadcast wave transmitted in an IBOC system modulation format. The IBOC broadcast receiver includes a diversity receiving unit, a broadcast selecting unit, a demodulating unit, and a control unit. The diversity receiving unit has a plurality of antennas for receiving a broadcast wave. The broadcast selecting unit has a broadband filter, a narrowband filter, and switches between and connects the broadcast wave to one of the filters and selects an output of the one of the filters. The demodulating unit demodulates a signal contained in the selected broadcast wave. The control unit is operably connected to the diversity receiving unit, the broadcast selecting unit, and the demodulating unit. The control unit determines whether or not the broadcast wave signal has an IBOC broadcast wave. In accordance with a result of the demodulation performed by the demodulating unit, upon determining that the broadcast wave signal has no IBOC broadcast wave, the control unit controls and places the diversity receiving unit into an enabled state and directs the broadcast selecting unit to select an output of the narrowband filter, and, upon determining that the broadcast wave signal has an IBOC broadcast wave, the control unit controls and places the diversity receiving unit into a disabled state and directs the broadcast selecting unit to select an output of the broadband filter.

According to the IBOC broadcast receiver of the present invention, when the control unit determines that the broadcast wave signal has an IBOC broadcast wave, the control unit selects an output of the broadband filter preferable for receiving an IBOC broadcast wave and controls and places the diversity receiving unit into a disabled state. That is, since the switching operation for switching the antennas is placed into a stopped state, this arrangement can eliminate inconvenience, such as “sync loss”, which has been encountered in the related art, at the time of switching to a digital modulation wave. Further, this arrangement can prevent a decline in the performance of IBOC broadcast reception. Thus, the IBOC broadcast receiver can perform optimum reception when receiving an IBOC broadcast wave.

When the control unit determines that the received broadcast wave signal has no IBOC broadcast wave, the control unit controls the diversity receiving unit such that it is placed into an enabled state (i.e., a state in which the switching operation, which contributes to an improvement in the performance of analog broadcast reception, for antenna switching is possible) and directs the broadcast selecting unit to select an output of the narrowband filter. That is, a “narrowband,” which is preferable for receiving an analog broadcast wave other than an IBOC broadcast wave, is selected, thereby making it possible to eliminate the inconvenience, such as having to detect an excessive frequency band, that has been encountered in the related art. This also makes it possible to prevent a decline in the performance of analog broadcast reception. Thus, optimum reception is possible during analog broadcast reception.

As described above, in the IBOC broadcast receiver according to the present invention, in accordance with an operational state of the IBOC demodulating unit, the filter switching (narrowband/broadband) of the broadcast selecting unit is performed in conjunction with the enabling/disabling of the diversity receiving unit. As a result, optimum reception is possible with respect to both IBOC broadcasting and analog broadcasting.

### BRIEF DESCRIPTION OF THE DRAWINGS

FIG. 1 is a schematic diagram for illustrating a broadcast wave transmission system (hybrid system) employed in an IBOC digital audio broadcast (DAB) system;

FIG. 2 is a block diagram schematically showing the configuration of an IBOC broadcast receiver according to an embodiment of the present invention; and

FIGS. 3A and 3B are block diagrams showing the operation of the IBOC broadcast receiver shown in FIG. 2, FIG. 3A showing a case when an analog reception signal is output and FIG. 3B showing a case when a digital reception signal is output.

### DESCRIPTION OF THE PREFERRED EMBODIMENT

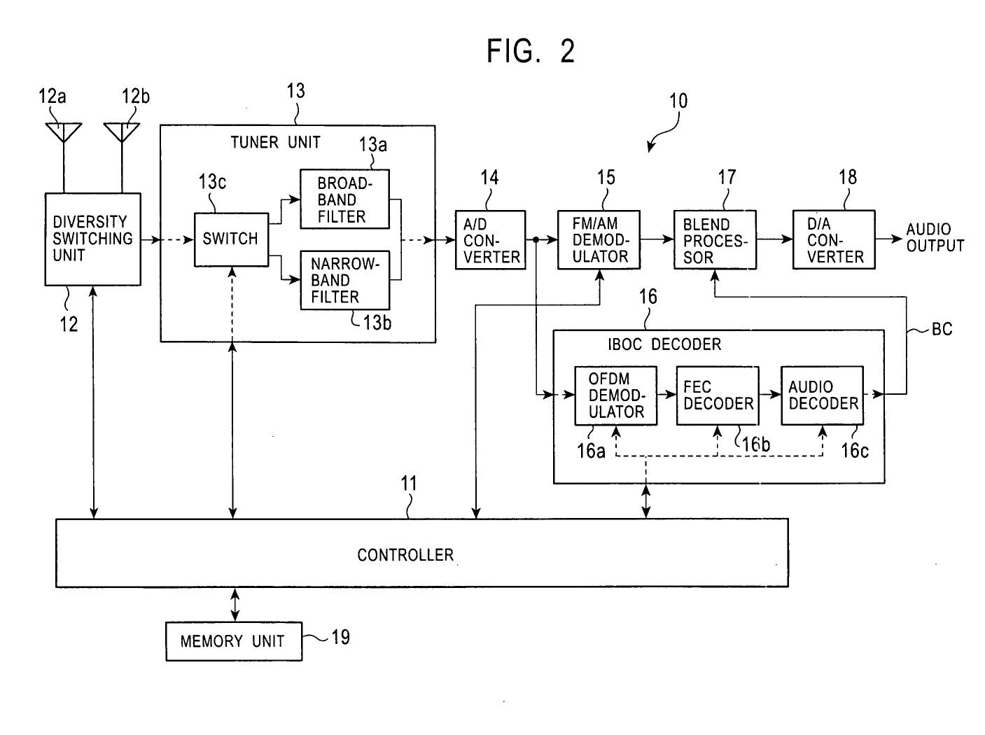

FIG. 2 is a block diagram schematically showing the configuration of an IBOC broadcast receiver according to an embodiment of the present invention.

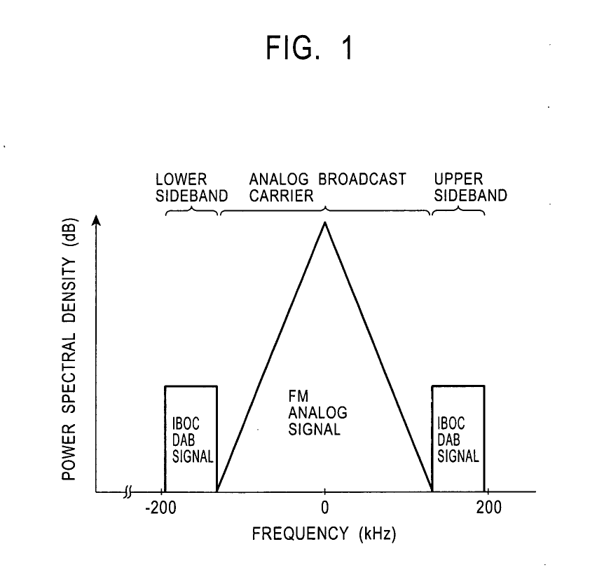

An IBOC broadcast receiver 10 according to the present embodiment is used on a vehicle and is adapted to receive a broadcast wave transmitted from an analog broadcast station that provides an existing FM/AM broadcast service and to receive a broadcast wave transmitted, in a hybrid-system modulated format (see FIG. 1), from an IBOC broadcast station that provides an IBOC-system digital audio broadcast (DAB) service. In the IBOC broadcast receiver 10, the controller 11 is implemented by a microcomputer or the like. As described below, one of the functions of the controller 11 is to control switching between an analog-reception signal and a digital-reception signal to be processed by the IBOC broadcast receiver 10.

A diversity switching unit 12 is provided to improve the performance of analog broadcast reception. The diversity switching unit 12 is coupled with a plurality of antennas (two antennas 12a and 12b are shown in the illustrated example), which are spaced away from each other. Through communication with the controller 11, the diversity switching unit 12 is placed into an enabled state or disabled state. The “enabled state” herein refers to a state in which the diversity switching unit 12 can perform a switching operating for switching between the antennas 12a and 12b, while the “disabled state” refers to a state in which the diversity switching unit 12 stops the switching operation, effectively selecting one of the antennas 12a or 12b.

A tuner unit 13 (an RF front end) tunes into the frequency of a broadcast wave (an analog broadcast wave or an IBOC broadcast wave) received via the diversity switching unit 12. Since a functional block involved in the frequency tuning is not directly associated with the substance of the present invention, that block is not illustrated. As functional blocks according to the present invention, the tuner unit 13 includes two types of filters, namely, a broadband filter 13a and a narrowband filter 13b. The broadband filter 13a has a bandwidth (about 400 kHz in the illustrated example in FIG. 1) that is suitable for receiving an IBOC broadcast wave and the narrowband filter 13b has a bandwidth (about 260 kHz in the illustrated example in FIG. 1) that is suitable for receiving an existing analog broadcast wave. The tuner unit 13 further includes a switch 13c for switching and connecting a broadcast wave, received via the diversity switching unit 12, to the corresponding filter 13a or 13b. By communicating with the controller 11, the tuner unit 13 switches between the filters 13a and 13b by using the switch 13c to select and output an output of one of the filters 13a and 13b.

An analog-to-digital (A/D) converter 14 converts the broadcast wave, selected and output by the tuner unit 13, into a digital signal. A FM/AM demodulator 15 is connected with the controller 11 to allow communication therewith. The FM/AM demodulator 15 digitally demodulates an FM/AM analog signal contained in the broadcast wave selected by the tuner unit 13 and sent via the A/D converter 14.

A IBOC decoder 16 is connected with the controller 11 to allow communication therewith. In an IBOC DAB (digital audio broadcast) system, the IBOC decoder 16 has known functional blocks. In the illustrated example, the IBOC decoder 16 has an OFDM (orthogonal frequency division multiplexing) demodulator 16a, an FEC (forward error correction) decoder 16b, and an audio decoder 16c. When a broadcast wave selected by the tuner unit 13 and output by the A/D converter 14 has a digital modulation wave, i.e., an OFDM subcarrier, the OFDM demodulator 16a demodulates the OFDM subcarrier. The FEC decoder 16b decodes a forward error correction applied due to digital encryption and audio compression performed by a transmitting end (an IBOC broadcast station). When the broadcast wave selected and output as described above contains an OFDM subcarrier (a digital modulation wave), the OFDM demodulator 16a uses its demodulation function. Thus, an output of the OFDM demodulator 16a indicates that synchronization with a digital modulation wave is established. Thus, through communication with the IBOC decoder 16, the controller 11 monitors the result of processing performed by the OFDM demodulator 16a (i.e., monitors whether synchronization with the digital modulation wave is established), thereby determining whether the selected broadcast station is providing an IBOC broadcast service.

A signal output by the IBOC decoder 16 (the audio decoder 16c) is supplied to a blend processor 17 as a blend control signal BC for controlling the blend function of the blend processor 17. In essence, in accordance with the state (i.e., the level) of the blend control signal BC, the blend processor 17 has a function for switching from an audio signal (analog broadcast wave) demodulated by the FM/AM demodulator 15 to the IBOC broadcast wave (digital modulation wave) and for relaying the resulting signal. By communicating with the IBOC decoder 16, the controller 11 can also directly monitor the state (level) of the blend control signal BC.

A digital-to-analog (D/A) converter 18 converts the digital audio signal sent via the blend processor 17 into an analog audio signal. The analog audio signal output from the D/A converter 18 is amplified by an audio amplifier, which is not shown, and the resulting audio is listened to by a user via a speaker. A memory unit 19, such as RAM (random access memory), is connected to the controller 11. The memory unit 19 stores, for example, data regarding broadcast frequencies of receivable broadcast stations (analog broadcast stations and IBOC broadcast stations).

In the IBOC broadcast receiver 10 configured as described above according to the present invention, the controller 11 corresponds to a “control unit”, the diversity switching unit 12 (including the antennas 12a and 12b) corresponds to a “diversity receiving unit”, the tuner unit 13 corresponds to a “broadcast selecting unit”, the FM/AM demodulator 15 corresponds to a “first demodulating unit”, the IBOC decoder 16 corresponds to a “second demodulating unit”, and the blend processor 17 corresponds to an “audio output switching unit”.

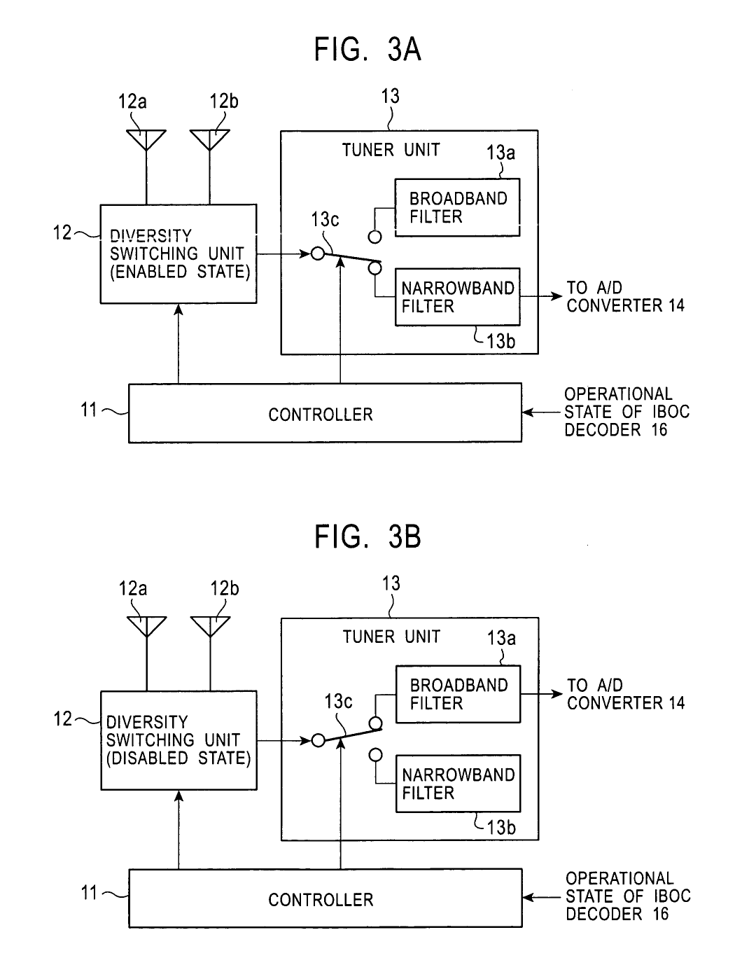

The operation of the IBOC broadcast receiver 10 of the present embodiment will now be described with reference to FIGS. 3A and 3B.

First, based upon the premise that a broadcast wave having a frequency tuned into at the time of searching for (seeking) a broadcast station is an IBOC broadcast wave, the functional blocks 12 and 13 are placed into an operational mode for receiving a digital signal. That is, as shown in FIG. 3B, under the control of the controller 11, the diversity switching unit 12 is placed into the disabled state and the tuner unit 13 is placed into a state in which an output of the broadband filter 13a is selected. In FIG. 3B, the “operational state of the IBOC decoder 16” being input to the controller 11 refers to the state of synchronization with a digital modulation wave and/or the state of the blend control signal BC.

After a predetermined time has elapsed, the controller 11 and the IBOC decoder 16 cooperate with each other to determine whether or not synchronization with a digital modulation wave is established (i.e., whether or not a broadcast having a frequency tuned into is an IBOC broadcast station or not). When it is determined to be an IBOC broadcast station, the tuner unit 13 sends the IBOC broadcast wave through the A/D converter 14 and the FM/AM demodulator 15.

On the other hand, when the broadcast station is determined to be not an IBOC broadcast station (i.e., to be an analog broadcast station), the controller 11 switches the functional blocks 12 and 13 into operational modes for receiving an analog signal. That is, as shown in FIG. 3A, under the control of the controller 11, the diversity switching unit 12 is placed into the enabled state and the tuner unit 13 is placed into a state in which an output of the narrowband filter 13b is selected. The tuner unit 13 then sends the analog broadcast wave through the A/D converter 14 and the FM/AM demodulator 15.

As described above, according to the configuration of the IBOC broadcast receiver 10 of the present invention, when the controller 11 determines through communication with the IBOC decoder 16 that a received broadcast signal has an IBOC broadcast wave, an output of the broadband filter 13a, which is preferable for receiving an IBOC broadcast wave, is selected, and the diversity switching unit 12 is placed into the disabled state. That is, since the switching operation for switching the antennas is placed into a stopped state, the IBOC broadcast receiver 10 can eliminate inconvenience, such as “sync loss”, which has been encountered in the known art, at the time of switching to a digital modulation wave. Further, the IBOC broadcast receiver 10 can prevent a decline in the performance of IBOC broadcast reception. Thus, the IBOC broadcast receiver 10 can perform optimum reception when receiving an IBOC broadcast wave.

When the controller 11 determines through communication with the IBOC decoder 16 that a received broadcast wave signal has no IBOC broadcast wave, the controller 11 controls the diversity switching unit 12 such that it is placed into the enabled state (i.e., a state in which the switching operation, which contributes to an improvement in the performance of analog broadcast reception, for antenna switching is possible) and directs the tuner unit 13 to select an output of the narrowband filter 13b. That is, the “narrowband” preferable for receiving an analog broadcast wave other than an IBOC broadcast wave is selected, thereby making it possible to eliminate the inconvenience, such as detecting an excessive frequency band, that has been encountered in the related art. This can prevent a decline in the performance of analog broadcast reception and further can perform optimum reception during analog broadcast reception.

The above description for the embodiment has been given for a case in which the operation is started in a state in which, under the control of the controller 11, the functional blocks are placed into the operations for receiving a digital signal (i.e., as shown in FIG. 3B, a state in which the diversity switching unit 12 is placed into the disabled state and the tuner unit 13 is placed into a state in which an output of the broadband filter 13a is selected). The operational mode performed by the IBOC broadcast receiver 10 of the embodiment, however, is not limited to the illustrated example, as is apparent from the spirit and scope of the present invention. For example, the operation may be started in a state in which, under the control of the controller 11, the functional blocks are placed into the operational modes for receiving an analog signal (i.e., as shown in FIG. 3A, a state in which the diversity switching unit 12 is placed into the enabled state and the tuner unit 13 is placed into a state in which an output of the narrowband filter 13b is selected).

In such a case, first, based upon the premise that a broadcast wave having a frequency that is tuned into at the time of searching for a broadcast station is an analog broadcast wave, the functional blocks 12 and 13 are placed into the “enabled state” and the “narrowband selection state,” respectively. At a predetermined time interval, the functional blocks 12 and 13 are switched into the “disabled state” and the “broadband selection state,” respectively, and the controller 11 and the IBOC decoder 16 cooperate with each other to determine whether or not synchronization with a digital modulation wave is established, that is, whether or not the broadcast station having the frequency that has been tuned into is an IBOC broadcast. When the broadcast station is determined to be an IBOC broadcast station, the functional block 13 sends the IBOC broadcast wave to the A/D converter 14. When it is determined to be not an IBOC broadcast station (i.e., to be an analog broadcast station), the functional blocks 12 and 13 are switched into the “enabled state” and “narrowband selection state,” respectively, thereby sending the analog broadcast wave to the A/D converter 14.

1. An in-band on-channel broadcast receiver for receiving a broadcast wave transmitted in an in-band on-channel system modulation format, the receiver comprising:
a receiving unit, having a plurality of antennas, receiving a broadcast wave from one of the antennas;
a selecting unit, having a broadband filter and a narrowband filter, receiving the broadcast wave from the receiving unit and selecting through which filter the broadcast wave is sent to produce a broadcast wave signal;
a demodulating unit receiving the broadcast wave signal from the selecting unit and demodulating a signal contained in the broadcast wave signal; and
a control unit, which is operably connected to the receiving unit, the selecting unit, and the demodulating unit, for determining whether or not the broadcast wave signal has an in-band on-channel broadcast wave,
wherein, upon determining that the broadcast wave signal has no in-band on-channel broadcast wave, the control unit permits the receiving unit to switch between antennas and directs the selecting unit to select the narrowband filter, and, upon determining that the broadcast wave signal has an in-band on-channel broadcast wave, the control unit prevents the receiving unit from switching between antennas and directs the selecting unit to select the broadband filter.

2. The in-band on-channel broadcast receiver of claim 1, further comprising an audio output switching unit, wherein the demodulating unit comprises a first demodulating unit for demodulating an analog signal contained in the broadcast wave signal and a second demodulating unit for demodulating, when the broadcast wave signal has a digital modulation wave, the digital modulation wave, and the audio output switching unit switches between the first demodulating unit and the second demodulating unit.

3. The in-band on-channel broadcast receiver of claim 2, wherein, upon determining that a digital modulation wave exists by referring to an output of the second demodulating unit, the control unit directs the audio output switching unit to select the output of the second demodulating unit.

4. The in-band on-channel broadcast receiver of claim 3, wherein the broadband filter has a bandwidth for receiving the in-band on-channel broadcast wave and the narrowband filter has a bandwidth for receiving an analog broadcast wave other than the in-band on-channel broadcast wave.

5. The in-band on-channel broadcast receiver according to claim 4, wherein the control unit determines whether or not the broadcast wave signal has an in-band on-channel broadcast wave at a predetermined time interval.

6. The in-band on-channel broadcast receiver of claim 4, wherein the in-band on-channel broadcast receiver is provided on a vehicle.

7. The in-band on-channel broadcast receiver of claim 3, wherein the control unit determines whether or not the broadcast wave signal has an in-band on-channel broadcast wave at a predetermined time interval.

8. The in-band on-channel broadcast receiver of claim 2, wherein the broadband filter has a bandwidth for receiving the in-band on-channel broadcast wave and the narrowband filter has a bandwidth for receiving an analog broadcast wave other than the in-band on-channel broadcast wave.

9. The in-band on-channel broadcast receiver of claim 8, wherein the in-band on-channel broadcast receiver is provided on a vehicle.

10. The in-band on-channel broadcast receiver of claim 2, wherein the control unit determines whether or not the broadcast wave signal has an in-band on-channel broadcast wave at a predetermined time interval.

11. The in-band on-channel broadcast receiver of claim 1, wherein the broadband filter has a bandwidth for receiving the in-band on-channel broadcast wave and the narrowband filter has a bandwidth for receiving an analog broadcast wave other than the in-band on-channel broadcast wave.

12. The in-band on-channel broadcast receiver of claim 1, wherein the receiving unit selects the antenna that has a the greatest reception electric-field strength.

13. The in-band on-channel broadcast receiver of claim 1, wherein the control unit determines whether or not the broadcast wave signal has an in-band on-channel broadcast wave at a predetermined time interval.

14. An in-band on-channel broadcast receiver for receiving a broadcast wave transmitted in an in-band on-channel system modulation format, the receiver comprising:
a receiving unit receiving a broadcast wave from an antenna;
a selecting unit having a broadband filter, a narrowband filter, and a switch for selecting between the broadband filter and the narrowband filter, the selecting unit receiving the broadcast wave from the receiving unit and supplying the broadcast wave to the filter selected to produce a broadcast wave signal;
a demodulating unit receiving the broadcast wave signal from the selecting unit and demodulating a signal contained in the broadcast wave signal; and
a control unit, which is operably connected to the receiving unit, the selecting unit, and the demodulating unit, for determining whether the broadcast wave signal has an in-band on-channel broadcast wave,
wherein, upon determining that the broadcast wave signal has no in-band on-channel broadcast wave, the control unit directs the selecting unit to select the narrowband filter, and, upon determining that the broadcast wave signal has an in-band on-channel broadcast wave, the control unit directs the selecting unit to select the broadband filter.

15. The in-band on-channel broadcast receiver of claim 14, wherein the broadband filter has a bandwidth for receiving the in-band on-channel broadcast wave and the narrowband filter has a bandwidth for receiving an analog broadcast wave other than the in-band on-channel broadcast wave.

16. The in-band on-channel broadcast receiver of claim 15, further comprising an audio output switching unit, wherein the demodulating unit comprises a first demodulating unit for demodulating an analog signal contained in the broadcast wave signal and a second demodulating unit for demodulating, when the broadcast wave signal has a digital modulation wave, the digital modulation wave, and the audio output switching unit switches from processing the output of the first demodulating unit to processing the output of the second demodulating unit when the control unit determines that the broadcast wave signal has a digital modulation wave.

17. The in-band on-channel broadcast receiver of claim 16, wherein the control unit determines whether the broadcast wave signal has an in-band on-channel broadcast wave based upon the demodulation performed by the demodulating unit.

18. An in-band on-channel broadcast receiver for receiving a broadcast wave transmitted in an in-band on-channel system modulation format, the receiver comprising:
a receiving unit, having a plurality of antennas, selecting an initial antenna from which to receive a broadcast wave;
a selecting unit, having a broadband filter and a narrowband filter, receiving the broadcast wave from the receiving unit and directing the broadcast wave to one of the filters to produce a broadcast wave signal;
a demodulating unit receiving the broadcast wave signal from the selecting unit and demodulating a signal contained in the broadcast wave signal; and
a control unit, which is operably connected to the receiving unit, the selecting unit, and the demodulating unit, for determining whether the broadcast wave signal has an in-band on-channel broadcast wave,
wherein, upon determining that the broadcast wave signal has no in-band on-channel broadcast wave, the control unit permits the receiving unit to switch antennas, and, upon determining that the broadcast wave signal has an in-band on-channel broadcast wave, the control unit prevents the receiving unit from switching antennas.

19. The in-band on-channel broadcast receiver of claim 18, wherein the broadband filter has a bandwidth for receiving the in-band on-channel broadcast wave and the narrowband filter has a bandwidth for receiving an analog broadcast wave other than the in-band on-channel broadcast wave.

20. The in-band on-channel broadcast receiver of claim 19, further comprising an audio output switching unit, wherein the demodulating unit comprises a first demodulating unit for demodulatimg an analog signal contained in the broadcast wave signal and a second demodulating unit for demodulating, when the broadcast wave signal has a digital modulation wave, the digital modulation wave, and the audio output switching unit switches from processing the output of the first demodulating unit to processing the output of the second demodulating unit when the control unit determines that the broadcast wave signal has a digital modulation wave.
